(19) United States
(12) Patent Application Publication
(10) Pub. No.: US 2008/0071662 A1
(43) Pub. Date: Mar. 20, 2008

(54) Reciprocal limited risk contracts and system for exchanging same

(76) Inventors: John Austin, London (GB); Nat le Roux, London (GB)

Correspondence Address: CLIFFORD CHANCE US LLP, 31 WEST 52ND STREET, NEW YORK, NY, 10019-6131, US

(21) Appl. No.: 11/521,006

(22) Filed: Sep. 14, 2006

Related U.S. Application Data
(60) Provisional application No. 60/842,792, filed on Sep. 6, 2006.

(51) Int. Cl. G06Q 40/00

(52) U.S. Cl. 705/37

(57) ABSTRACT

A bracket trade is provided wherein a bracket trade is a reciprocal risk limitation futures contract with two stops placed at determined levels on either side of a present value of an underlying market, so a possible range in which the exchange's quotation can move once the trade has been opened is ‘bracketed’ by these two levels. The brackets function as trigger stops. If the stop or limit is triggered, the position is closed at exactly that level without slippage. As a result, in respect of an underlying market that is traded 24 hours a day the bracket trade has a delta of 1 regardless of the fluctuations of the underlying market or proximity of the exchange's quotation to the brackets; and where the underlying is not traded 24 hours a day the bracket trade will have a delta of 1 on the expiry day of the contract. Bracket trades provide a means by which exchange members can trade at a transparent market price but with the safety of a limited risk stop.

### CROSS REFERENCE TO RELATED APPLICATIONS

This application claims priority to U.S. Provisional Patent Application Ser. No. 60/842,729 filed Sep. 6, 2006.

### FIELD OF THE INVENTION

The invention relates to the field of exchange traded futures contracts, and, more specifically, an exchange designed for transactions that are subject to capped profits and losses so that they can be fully collateralized in advance because the maximum exposure of both parties is limited and exactly quantifiable in advance of the transaction.

### BACKGROUND OF THE INVENTION

Traditional derivatives exchanges have at most a few dozen full account carrying members. These members are commercial concerns, often quite sizeable, who derive their revenue from, inter alia, commissions charged to non-members for the execution of on-exchange transactions and carrying of their accounts. The exchange itself derives its revenue from transactional fees levied on the members.

All contracts, however executed, are novated so that the exchange itself, or its clearing facility, stands on one side of every contract and a specifically designated, financially responsible member, each a “clearing member,” on the other. Because derivative contract values are subject to change with market conditions, contract parties are normally required to post a good faith payment called margin to ensure performance and to pay additional variation margin as market conditions require. The exchange collects initial and variation margins from members, and applies margin rates and methodology overseen by the regulator. The members in turn collect margins from their customers. Minimum margin rates for customers are set by the exchange and overseen by the regulator.

Under this model, exchange clearing members have open-ended obligations. They must thus have substantial financial standing, and are required to submit periodic returns to the exchange.

Traditional options and futures contracts involve at least one party to the transaction taking on unlimited risk. In the case of traditional exchange traded options, for example, whilst the risk to the option taker may be limited and quantifiable (i.e., the amount of premium paid), the risk to a call option writer is unlimited as price can rise infinitely and a put option writer risk price dropping to zero. In the case of futures, whilst in most cases the party going long takes on the risk of the contract's value falling to zero, the party going short faces an unlimited risk.

This feature—that the risk faced by both parties cannot simultaneously be limited—is common to nearly all commercially available derivative contracts, including both on and off exchange products such as futures, options, contracts for differences, spread bets etc.

In addition, established futures and options exchanges, can be difficult for retail customers to use. As they exist primarily to serve an institutional clientele their contract sizes are often larger than the average retail customer needs or can afford. Further, the exchanges are not open to members of the public but only to exchange members who act as brokers, placing trades on the client's behalf. This increases the cost of entering transactions as the brokers must be paid a commission.

With the exception of buying options, contracts traded on traditional derivatives exchanges are subject to a very wide and indeterminate range of possible profits and losses. As a result there is a considerable credit risk to the counterparty and most traditional exchanges have their contracts cleared by a central clearing facility which takes on the credit risk. The central clearing facility is willing to do so because it is able to place reliance on corporate clearing members to pay sufficient variation margin to keep their positions open. Retail customers might not be able to make margin payments sufficiently fast enough, and a central clearing facility would be unwilling to take on the credit risk of individuals.

As a consequence exchange memberships are generally limited to corporate clearing members and other market professionals and the retail customer can only gain access to the market, place orders and execute transactions via the agency of a broker, to whom the customer must pay a commission.

The advent of electronic (as opposed to face-to-face open-outcry) trading opened the way for an alternative exchange model in which the end-users are themselves the exchange members. These exchanges extend this model to the retail market by allowing members of the general public to sign up directly as exchange members without being required to demonstrate creditworthiness.

Prudence, as manifested in the views of the Commodity Futures Trading Commission (CFTC), which regulates futures trading, concludes that a futures exchange clearing facility cannot reliably variation-margin the open ended futures contract obligation of a membership that consists of thousands of individuals of uncertain financial standing. As a consequence, all transactions on an electronic retail exchange must be subject to capped profits and losses so that they can be fully collateralized in advance, and the exchange is thus restricted to listing contracts where the maximum exposure of both parties is limited and exactly quantifiable in advance of the transaction (hereafter called reciprocal limited risk contracts). By opening specially designed contracts that obviate the need for payments of variation margin, the electronic retail exchange is able to offer membership to US retail customers, who are able to deposit funds, place orders and execute transactions directly without the involvement of an intermediary.

Outside the US there are a number of providers of over-the counter (“OTC”) derivative products, including reciprocal limited risk contracts, to the retail market. This market is most advanced in the UK, where a range of products including contracts for differences, spread bets and binaries (see below) are offered by providers acting as off exchange market makers to their retail customers.

At present, there are only two types of reciprocal limited risk contracts offered: the “binary option” and the “range trade”. Binary options (also called digital or all or nothing options) are a form of option that is only capable of two possible outcomes on expiry; if the condition is satisfied the option pays a fixed amount and if the condition is not satisfied the option pays nothing. Binary options can be European or American style and structured as puts or calls. The payout can be either the value of the underlying or a fixed amount. For example, a European style fixed amount binary call pays a given amount of money if the option expires in the money (i.e., with the underlying above the strike price) and pays nothing if it expires with the underlying below the strike price. An American style fixed payout binary option would be issued out of the money and will make a fixed payment if the underlying ever reaches or goes beyond the strike price. The payment may be made immediately or at expiry. A European binary option based on the value of the underlying asset will pay out the value of that asset if, at expiration, the value is greater than the strike price. There is still an all or nothing discontinuous payment profile, but the amount of the payment is determined by the value of the underlying asset rather than having been agreed in advance.

Binary options are typically quoted on a 0-100 index. If the strike price is hit the option settles at 100, if it is not then the option settles at 0. The price of the option is thus not quoted on the same basis as the price of the underlying market, making it difficult for retail customers to understand.

For example, a binary option has a few minutes to expiry. With the underlying market at or very close to the strike price, wild price swings will be seen in the option value despite only very small price changes in the underlying. A 0-100 binary call on a third party index with a strike price at 11500 will be valued at 50 if the underlying market is priced at 11500. However, if the option is within minutes of expiry the price of the binary call may jump to 100 (i.e., may double in price) in response to the underlying market increasing by just 5 points (0.04%) to 11505. Or it may drop to zero in response to a 5 point move downward in the underlying.

Conversely, if the binary option has several days or weeks before expiry, a 5 point move (in either direction) in the underlying market may have no discernible impact on the price of the option—it would remain at a price of 50 throughout.

Another relevant variable is the distance between the strike price and the level of the underlying market. If the strike is at, say, 11500, and the underlying market is trading at, say, 10000, then the option will be priced very close to zero, whether it has 5 minutes to run before expiry or 5 days. And its price will not respond to movements in the underlying at all, unless the underlying makes a very dramatic move upward toward 11500.

In short, there is no easy rule of thumb for describing the “delta” (i.e., the sensitivity in option price to movements in the underlying index) of a binary option—it is a complex product of factors such as time to expiry, distance between strike price and underlying price and volatility of the underlying market. The delta (Δ) of a binary call can be calculated by the formula: Δ=[e−r(T−t)N′(d)]/[σS√(T−t)], where d=[log(S/E)+(r−D−½σ2)(T−t)]/[σ√(T−t)], r is the interest rate, T−t is the time to expiry, σ is the standard deviation in returns of the underlying market (i.e., its volatility), S is the level of the underlying market, E is the strike price of the call, and N′(x) is the function 1/√2πe−(½)x2. This formula is unlikely to be understood or used by most retail users/investors.

A range trade has the same economic effect as a vanilla option call spread, but is offered as a package where the selection of strikes is determined by the exchange (or OTC market-maker). In the UK, range trades have been structured as a series of individual fixed odds bets entered into between a bookmaker and its client covering every possible outcome, and allocating different odds and/or stakes to each potential outcome in order to produce an incremental payout profile that is similar to or the same as a spread bet on the same underlying market.

A feature of range trades is that as the market price approaches the boundaries of the range the price begins to demonstrate the effect of optionality as the discontinuous payment profile of the binary option becomes applicable. A variety of range trades called “Binary futures hedgelets” have a variable payout within upper and lower caps. The contract is based on an underlying asset and is traded within a predetermined range. Each contract has a maximum payout and the value of the contract moves with each incremental movement in the underlying.

Range trades do not exhibit price movements that are as erratic as binary options, as their deltas are limited at a maximum of 1 (i.e., their price cannot move by more points than the underlying at any stage). However, they do exhibit option-like behavior at the edges of their range (i.e., when the underlying level is close to or beyond either the cap or the floor of the range trade contract). In these areas, their delta will drop to 0.5 or lower. So a third party index range trade with a floor at 11100 and a cap at 11200 will move one-for-one with the underlying index provided that the index is at 11150. If the index drops toward 11100 then the value of the range trade contract will also decrease, but not by the same number of points—it may, for example, drop by 0.75 points for every point drop in the underlying (the precise delta ratio is dependent on precisely how long the contract has until expiry and how close the underlying gets to 11100). If the underlying drops to 11100, the range trade will change in value by 0.5 points for every point movement in the underlying. If the underlying drops below the 11100 floor the range trade will still have value, but will change in value by less than 0.5 points for every point movement in the underlying market (again, the precise delta and indeed value of the contract under these conditions is a complex product of time to expiry, market volatility and distance between the floor level of the contract and the level of the underlying market).

Thus, the pricing of both binary options and range trades contains an element of optionality, which results in erratic price behavior when the underlying market is trading around one of the specified contract-defining levels. This is confusing to less sophisticated users. Therefore, there remains a need in the art for reciprocal limited risk futures contracts that are easily understandable to users of all levels of experience.

### SUMMARY OF THE INVENTION

The present invention has met the hereinbefore described need.

The invention provides a futures contract and a system of trading futures contracts on an exchange, wherein the contracts are reciprocal limited risk contracts that have a delta of 1 on the expiry day, thereby providing limited risk to all parties while eliminating erratic price behavior endemic to other types of contracts that seek to limit risks.

Therefore, it is an object of the present invention to provide a future and a system for trading futures including the steps of selecting an underlying market having a present value, wherein the present value is a quoted point of the underlying market, determining a cap stop value, the cap stop value a number higher than the present value, determining a floor stop value, the floor stop value a number lower than the present value such that the cap stop value and the floor stop value form a bracket around the present value, listing the bracket, opening a contract at an opening value with an exchange member or facilitating a contract between two exchange members based on the bracket, wherein the opening value is the present value at the time of opening, and stopping the contract if a stop is triggered, wherein the stop is triggered if the present value equals the cap stop value or the floor stop value.

It is a further object of the present invention to provide a web-based, computer implemented method of bracket trading on an exchange, including the steps of opening a contract on the exchange, the contract opened at a present value of an underlying market between two bracket stop values that form a bracket, wherein the two bracket stop values correspond to potential values of the underlying market and wherein the present value fluctuates in correlation to fluctuations in the underlying market, and stopping the contract when the present value equals either of the two bracket stop values, wherein that a delta of the contract is always 1 on the expiry day.

It is a further object of the present invention to provide an exchange for trading a financial instrument including a web-based interface for accepting inputs from at least one exchange member, means for listing a bracket on the interface, the bracket including two bracket stop values such that a present value of a selected underlying market is between the two bracket stop values, wherein the two bracket stop values correspond to potential values of the underlying market, and wherein the present value fluctuates in correlation to fluctuations in the underlying market, means to open a contract with input from the exchange member, the contract having risk and profit take limitations that correspond to the two bracket stop values, and means to stop the contract at a moment where the present value equals one of the two bracket values.

It is a further object of the invention to provide a futures contract having a first bracket stop value corresponding to a first potential value of an underlying market, the underlying market having a present value wherein the present value fluctuates in correlation to fluctuations in the underlying market, a second bracket stop value corresponding to a second potential value of the underlying market, an opening value, wherein the opening value is the present value of the underlying market at the time of an opening of the futures contract, the present value between the first and second potential values, and a stop trigger, wherein the stop trigger stops the contract when the present value equals either of the two bracket stop values, wherein a delta of the futures contract is always 1 on the expiry day.

It is a further object of the invention to eliminate erratic behavior endemic to the nature of the contract, especially when the underlying market is volatile or the present value of the underlying market approaches a bracket stop value.

It is a further object of the invention to provide an exchange and an exchange listed contract capable of being regulated by the CFTC under the CEA, or other regulatory bodies.

It is a further object of the invention to provide a contract having a price that correlates at a one-to-one ratio with the present value of the underlying market throughout a lifespan of the contract at all times where the underlying market is traded.

It is a further object of the invention to settle the contract after stopping the contract, wherein a price of the contract is the difference between the opening value and the present value at a time the contract is stopped, multiplied by a price per point.

It is a further object of the invention to list one or more brackets on the exchange.

It is a further object of the invention to suspend listing the contract having a specified bracket from the exchange after the present value equals either of the two bracket stop values.

It is a further object of the invention to reinstitute the bracket on the exchange list after the present value equals either of the two bracket stop values if the present value of the underlying market moves back between the two bracket stop values.

It is a further object of the invention to have an exchange wherein the exchange members are members of a general public and/or intermediaries.

These and other objects of the invention will be more fully understood from the following description of the invention and on reference to the illustrations appended hereto.

### BRIEF DESCRIPTION OF THE DRAWING

A full understanding of the invention can be gained from the following description of the preferred embodiments when read in conjunction with the accompanying drawings in which:

FIG. 1 is a flow chart of a system for trading reciprocal limited risk contracts.

FIG. 2 is a block diagram of determination of brackets by an exchange.

FIG. 3a is a block diagram of a transaction of a reciprocal limited risk contract having a delta of 1 between an exchange and an exchange member.

FIG. 3b is a block diagram of a transaction of a reciprocal limited risk contract having a delta of 1 between two exchange members.

FIG. 4 is a flow chart of a system for trading reciprocal limited risk contracts having a delta of 1.

### DETAILED DESCRIPTION OF THE PREFERRED EMBODIMENTS

As used herein the term “bracket” means two number values, wherein a first number value is higher than a present value of an underlying market, and the second number value is below the present value of the underlying market. The term “bracket” definition may interchangeably refer to only the first and second number value or to the combination of the first number value, the second number value and the present value.

As used herein the term “opening a bracket contract” means a purchasing of a futures instrument, wherein the exchange is counter-party to an exchange member or wherein two exchange members agree to trade and through immediate novation the exchange becomes counter-party to each such exchange member.

As used herein the term “settling a bracket contract” means determining the profits or losses of both the exchange member and the exchange upon stopping the contract.

As used herein the term “bracket trade” refers to overall act of opening, holding, stopping and settling a bracket contract in accordance with the invention.

As used herein the term “present value” refers to a value equivalent to a quoted point or range of points for a selected underlying market, wherein the present value is pinned to the quote point such that present value fluctuates with the point fluctuations of the underlying market.

As used herein, a “price-per-point” means a ratio of an amount of money that exchange members (and the exchange) stands to gain or lose to a single point value of an underlying market.

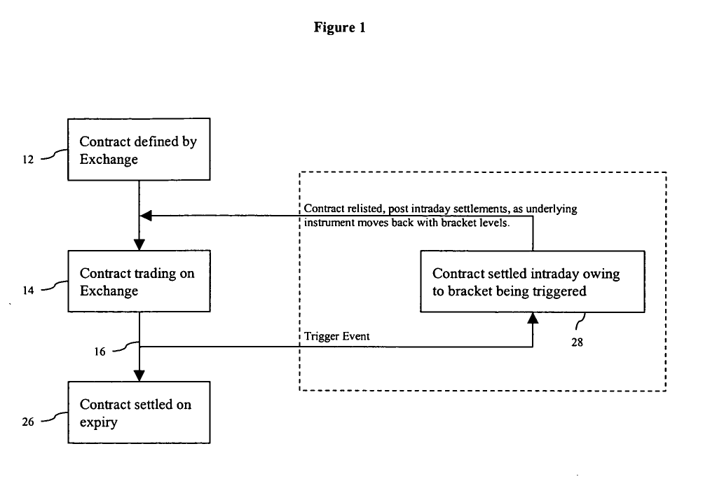

One embodiment of a system for trading reciprocal limited risk contracts of the invention, i.e. bracket contracts, on an exchange is shown in FIG. 1. In general, one or a multiplicity of brackets are defined in step 12, wherein each bracket includes two number values on either side of a present value of an underlying market. Each bracket presents a contract opportunity for one or a multiplicity of exchange members. Futures contracts based on the brackets can then be entered into by one or a multiplicity of exchange members in step 14 such that the one or a multiplicity of exchange members is counter party to one other of the one or a multiplicity of exchange members, or the exchange or a market maker on the exchange is counterparty to the one or a multiplicity of exchange members, or a combination of both. The entered futures contracts, which in this embodiment are bracket contracts, are settled upon a trigger event 16. After the bracket contract is stopped in trigger event 16, the bracket contract is settled in steps 26 or 28 wherein it is determined what the exchange and exchange member's profits and losses are. If the trigger event 16 is a bracket triggering, as further explained below, the bracket contract is settled in step 28 and the bracket may be reinstituted if the underlying market moves back between the bracket.

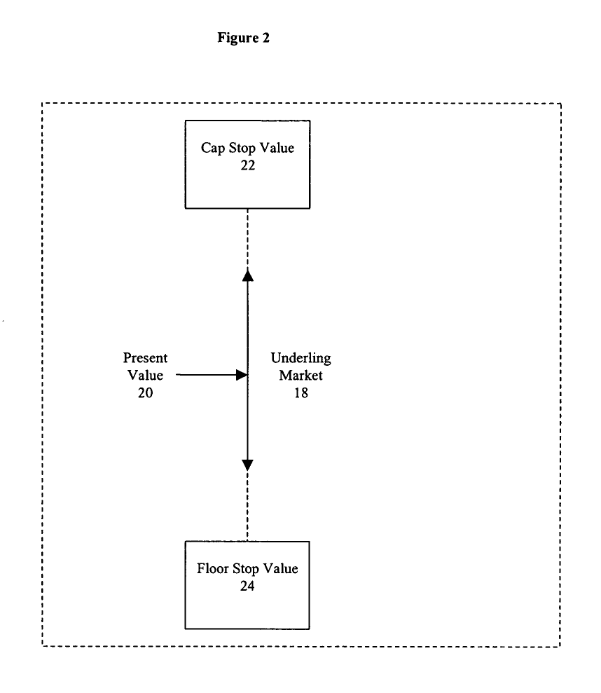

The bracket is shown in greater detail in FIG. 2. Each bracket is based on an underlying market 18 wherein underlying market 18 has a present value 20. Underlying market 18 is preferably any market/index having a quoted point value or like indicator, wherein the quoted point value is typically a number value or a value range that represents a performance level of the underlying market.

A wide variety of indices including stock indices can be used as the underlying market. In preferred embodiments, the underlying market has a continuously quoted externally verifiable price, e.g. individual equities, commodities and tradable securities. In further preferred embodiments, the underlying markets are those that are (i.) high profile (and thus interesting to many investors), and (ii.) quoted for as many hours per day as possible (avoiding the risk of any material “gapping” between sessions, as the higher this risk is, the less linear is the behavior of the contract when it approaches its trigger levels). In these embodiments, cash stock markets and equity prices score highly on (i.). Futures contracts on stock markets, FX rates or commodities score less highly on point (i.) but more highly on (ii.). The invention has general applicability to all markets, however, so long as they are not prohibited by regulatory and/or copyright concerns.

Present value 20 is the instant and most recent quoted point value. Present value 20, as would readily be understood, is pinned to the underlying market's quoted index such that fluctuations in the index also cause fluctuations in present value 20. Thus, present value 20 can increase and decrease due to any number of market forces. If the underlying market's quoted index is a range, the present value corresponds to a center of the range. In preferred embodiments, while each bracket contract uses a single underlying market, exchange 10 preferably offers a variety of bracket contracts that may each rely on the same or a different underlying market.

The bracket further includes two risk limitation stops—cap stop value 22 and floor stop value 24—on either side present value 20, thereby forming a ‘bracket’ around present value 20. Generally, cap stop value 22 will be a potential value higher than present value 20 while floor stop value 24 will be a potential value lower than present value 20. The cap and floor stop values function as bracketing trigger stops that limit the risk and life-span of the bracket contracts. Essentially, the two risk limitation stops are d values that present value 20 may equal due to fluctuations in the underlying market. While the present value 20 is variable in accordance with the fluctuations of underlying market 18, cap stop value 22 and floor stop value 24 are static and stay the same value the length of the bracket contract or for as long as they are listed.

For example, if an underlying market has a quote point value of 10500, present value 20 will also be 10500, wherein present value 20 will fluctuate with the fluctuations of the underlying market on a 1:1 basis. The exchange will then determine a cap value 22 above present value 20 and a floor value 24 below present value 20. Thus, cap stop value 22 may be determined to be 10550 and floor stop value may be determined to be 10450. While a bracket is generally chosen so that present value 20 is somewhat centrally located between the two risk limitation stops, present value 20 can be any value between the brackets. Therefore, if the present value was 10500, cap stop value could have been 10505 and floor value 10405.

The difference between the cap stop value and the floor stop value is called the bracket difference. The bracket difference can vary widely. In preferred embodiments, as in the example just above, the bracket difference is 100 for ease of use. However, the brackets could have been 10550 and 10375 or any other cap and floor stop value combinations that bracket 10500.

Typically, if the bracket contracts are available for opening on any given exchange 10, that exchange 10 will determine, at minimum, the underlying market and bracket stops for each bracket as desired. While each bracket includes a single cap stop value, a single floor stop value and corresponds to a single underlying market, exchange 10 preferably includes a multiplicity of brackets, each representing a separate class of bracket contract. Any number of the multiplicity of brackets can correspond to the same underlying market, thus creating overlapping brackets (bracket contract classes) on the same underlying market. The overlapping brackets may each have different bracket differences, may have higher or lower scaled cap and/or floor values, or a combination of both.

Once a bracket is defined by the exchange, it is preferably listed on the exchange such that the bracket is accessible to exchange members. Listing the bracket means that the bracket is active and bracket contracts can be opened based on it. The exchange preferably lists series of overlapping bracket trades for each underlying market offered. For example, the exchange might list the following brackets for an index: a 5950/6050 bracket; a 5950/6100 bracket; a 6000/6050 bracket; a 6000/6100 bracket, and so forth. The brackets are listed on the exchange for any length of time desired by the exchange, for example, one day, one month or longer. Preferably, brackets are listed on-line such that the exchange member can visually see and research the brackets on-line, if needed, prior to opening a bracket contract from a remote source with an Internet connection. In addition, embodiment may simultaneously or alternatively be accessible off-line, for example, in a printed publication.

Contracts can be opened by exchange members. Exchange members may be any individual, group or institution, and are not substantially limited in number. In the present invention, members of the general public are eligible to register directly on the exchange as exchange members. This is in contrast to traditional exchanges that have at most a relatively small number of full members, wherein the few full members derive their revenue from, among other things, commissions charged to non-members for the execution of on-exchange transactions. The ability for the general public to directly sign up on the exchange as exchange members is aided in great part by the reciprocal limited risk provided by the brackets. The reciprocal limited risk permits the exchange to meet a core risk management principal required under the CEA as administered by the CFTC, for the financial clearing function. The brackets or exchange are functional, however, no matter what statute or body, if any, regulated it, and thus the brackets or exchange are equally functional if regulated under securities laws or other regulatory statute. In preferred embodiments, members of the general public provide the exchange a predetermined level of identification and payment information to the exchange in order to be granted exchange membership. The exchange can further incorporate any variety of rules or conventions for allowing a user to become an exchange member or allowing an exchange member to enter a bracket contract on the exchange. For example, in one embodiment, a potential customer completes an application to ensure the customer passes basic requirements for membership. Further, the exchange member preferably receives a verification that identifies the customer as an exchange member. Verification can be any type of verification known in the art, for example a screen name and password as either chosen by the exchange member or the exchange. Each exchange member is further given an account wherein the exchange can credit or debit the account depending on the price of bracket contracts traded.

To open a bracket contract (a.k.a. begin a bracket trade) on the exchange, an exchange member trades with another exchange member such that upon novation the exchange or its associated clearing organization is counterparty to the exchange member. In alternate embodiments, to open a bracket trade, an exchange member trades directly with the exchange such that the exchange (through its clearing facility) is counterparty to the exchange member without novation.

The bracket contract is fully collateralized by the exchange member prior to completion of the opening such that the exchange member provides collateral for a maximum amount of loss possible under the bracket contract. Collateralizing the bracket contract can be done by any process known in the art. In one embodiment, the exchange member can credit his own account to cover any maximum losses that may occur in outstanding or potential bracket contracts. In preferred embodiments, the credit is then deducted from the exchange member's account upon entry into the bracket contract. In addition to requiring payment to cover any potential losses, when a bracket contract is opened, the exchange preferably charges exchange members a small transaction fee.

Preferably bracket contracts are opened electronically. The present invention is readily implemented on a system of networked computers such as a local area network or a wide area network (the Internet.) The exchange itself may be implemented on one or a series of general purpose computers under the control of a software program or like programming, wherein the exchange can preferably be readily accessed on-line from remote locations.

The invention preferably includes an Internet accessible, interactive, web-based interface that can accept inputs from exchange members and exchange administrators remote to the exchange's location as well as associated programming used to generate the interface. The interactive, web-based interface preferably allows exchange members to perform desired activities via Internet or network, such as registering themselves, researching markets, instigating and tracking bracket trades and settling stopped bracket contracts. As the Internet can be accessed by an exchange member by any known connective device, exchange members can trade in any country or location having Internet access. In alternate embodiments, the exchange may be or incorporate a physical location such as a trading floor where trades are physically made.

The bracket contracts of the present invention are futures contracts wherein all contracts are opened with two attached stop orders, i.e., two bracket stop values. The two bracket stop values act as a risk limitation stop to close the trade should the market move against the exchange member and a take profit stop to realize the exchange member's profit should the market move in his favor. When the exchange member opens the bracket contract he will know exactly where the bracket stop values are placed from the listing on the exchange. For example, a 5650/5750 Bracket has stops at 5650 and 5750. So if the exchange member goes long of this trade, a risk-limitation stop is at 5650 and a take-profit stop is at 5750. If the exchange member goes short, a risk-limitation stop is at 5750 and a take-profit stop is at 5650. The customer cannot move these stops, or elect to place his own stops at different levels. However, as stated above the exchange preferably offers two or more overlapping ‘brackets’ on each underlying market, allowing exchange members a choice of brackets.

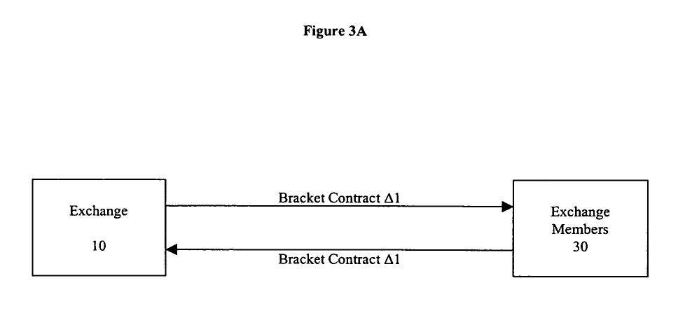

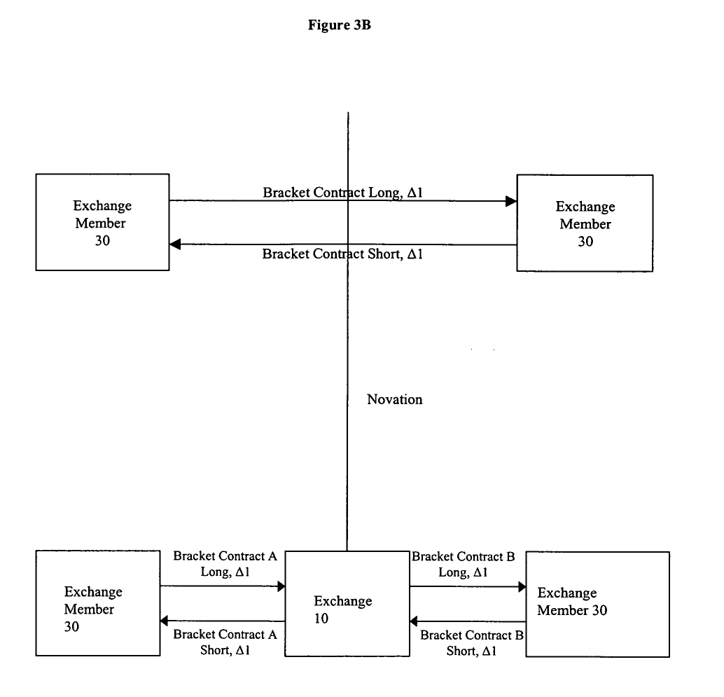

Exchange 10 can be any type of exchange. Some exchanges are multilateral trade execution facilities, wherein multiple exchange members may offer to open contracts with other exchange members. In this instance, as shown in FIG. 3b, two exchange members form a bracket contract with agreed upon terms, such that one exchange member goes long and the other exchange member goes short in an equal measure. The exchange may have an electronic or other matching system to pair together matching offers. One, both or neither of these member may be persons designated by the exchange as market makers. In preferred embodiments, the bracket contracts are subsequently immediately novated such that the exchange becomes counter-party to both exchange members, essentially creating two contracts, shown in FIG. 3b as contracts A and B. Thus, the exchange member will either trade with another exchange member (i.e., another member of the public) and/or will trade with the exchange's market maker (i.e., another exchange member that happens to be a separate entity) but not with the exchange itself other than by novation. In alternative embodiments, the exchange may be a many against one exchange, wherein all exchange members must contract directly with the exchange or a designated market maker. In this embodiment, as shown in FIG. 3a, once a bracket contract has been listed for trading, exchange 10 can interact directly with exchange member 30 without intervening parties. The exchange member offers to open a bracket contract short or long and the exchange either automatically or at its discretion takes the counter-party bracket contract. Further types of exchanges include a combination of the above, wherein the exchange is a many against many with a market maker option. Any other types of exchanges are usable as well. The brackets and bracket contracts of the invention are fully functional in of themselves apart from the exchange or any particular type of exchange.

In FIGS. 3a and 3b, exchange members open the bracket contract at present value 20 of underlying market 18. The precise present value at which the exchange member opens the bracket contract is an opening value. The exchange member can elect a ‘price-per-point, wherein the exchange member's potential profit or loss is a function of a change of point value of the underlying market multiplied by the price-per-point. For example, if the exchange member elects a US$10 price-per-point, the exchange member will either gain or lose US$10 per every numerical point change of underlying market 18, i.e., 10:1. The price per point ratio does not change regardless of the fluctuations of the underlying market, or even as the bracket contract approaches either bracket. Thus, mathematically, a delta (Δ) of the bracket trade is always 1 on a day of expiry, wherein the delta represents sensitivity in the bracket trade price to movements in the underlying index. In alternate embodiments, a single price-per-point is set by the exchange at any given time and cannot be changed by the exchange members.

Bracket contracts are preferably further defined in terms of units of currency per point of the underlying market or, in the case of underlying commodity markets, in terms of units of weight, volume, size or other quantitative measure. In the latter embodiment, if used with, for instance, a gold commodity market, the bracket contract may be defined by 10 oz of gold as opposed to $10 per point of the price per ounce. In embodiments wherein the bracket contract are defined in terms of units of currency per point, the exchange may offer one or a multiplicity of currencies for the exchange members election. In preferred embodiments, however, only a single currency is offered on all brackets relating to the same underlying market. Therefore, for example, exchange members would not be faced with a choice between $-denominated bracket contracts and £-denominated bracket contract on the same index.

It is a significant advantage of the present invention that the price and price-per-point of the bracket contracts have a delta of 1 on the expiry day no matter where present value 20 is in relation to the cap stop value or the floor stop value on the expiry day. Where the underlying market is traded continuously, there is no gap risk in the bracket contracts, and consequently the price of the bracket contracts move one-for-one with the value of the underlying market, even when close to a bracket level. For example, if the underlying market is at 10504 and a bracket is 10500/10600, a bracket contract can be traded at the same price per point level than if the underlying market was at 10550. This is a key advantage from the point of view of an exchange member who lacks significant knowledge of advanced financial mathematics. Further, the value and price sensitivity of the bracket contract is unaffected by the volatility of the underlying market. This contrasts prior art bracket trading or binary options trading that has, as discussed in the background section, significant price fluctuations, particularly where the underlying market approaches or exceeds bracket levels or if the underlying market is volatile. There is abundant evidence that, where both product types are available, non-professional traders overwhelmingly prefer a simple geared scalar instrument with guaranteed risk limitation to the corresponding option as it is significantly easier to price a scalar future than an option.

Once a bracket contract is opened, the bracket contract is active until an event triggers stoppage of the bracket contract. One such event is the bracket trigger stop where present value 20 equals the risk stop limitation or the profit stop limitation, i.e., either the cap stop value or the floor stop value depending on whether the exchange member went long or short. In other words, once present value 20 of underlying market 18 ‘touches’ either side of the bracket, the bracket contract ends and is closed at exactly that level. This occurs automatically and without input of the exchange or exchange members even if a time limitation placed on the bracket contract has not yet expired. Profit or loss of the exchange member (and, on the opposing side, the exchange) is determined by the difference between the opening value and the value of whichever stop limitation was touched, multiplied by the price-per-point. Upon stoppage of the bracket contracts, all settlements are preferably electronically settled in credit or cash with no physical delivery.

The present invention, by immediately stopping the bracket contract when a bracket limitation is reached, provides an attractive and readily understandable investment opportunity to traders. Since the bracket contract is stopped immediately upon touching either side of the bracket (i.e., stopped early as compared to the time limitation), there is no further uncertainty about the settlement level of the bracket contract and no danger of slippage wherein present value 20 falls back between the bracket stop values and potential gains are lost. With prior art future contracts, by contrast, the contract remains live, and has a potential to change in price, even if the underlying goes beyond either the cap or the floor of the contract (because the underlying may return into the cap floor range before expiry). Thus, the bracket trade provides a futures contract with a built-in stop and limit set at levels determined by the exchange and a means by which exchange members can trade at a transparent market price but with the safety of a limited risk stop. Since there is a stop for both profit and take, there is limited risk for the exchange as well as the exchange member, thereby providing reciprocal risk limitation.

If a bracket is stopped when the value of the underlying market touches either side of the bracket, the bracket is suspended from listing. Suspension from listing means that the bracket is no longer active to have bracket contracts opened with the bracket's cap and floor stop values. No bracket trading can occur when present value 20 is not between the cap stop value or the floor stop value. However, the bracket, even if suspended, may still be referenced on the exchange in some way, for example, it may be visible to exchange members as a record of past trades. A bracket can also be suspended by discretion of the exchange. In preferred embodiments of the invention, any bracket that is suspended can reinstituted on the list at a later time if the present value of the underlying market moves back in between the bracket's cap stop value and floor stop value. Reinstituting the bracket on the list re-activates the bracket and makes bracket contracts based on the risk and profit stop limitations once again available for opening, although it does not reestablish extinguished bracket contracts. In preferred embodiments, any suspension or reinstitution of a bracket is automated and requires no involvement from the exchange. In this circumstance, the reinstitution to the list preferably occurs during a next time period wherein the underlying market is no longer being traded, i.e., after a day's trading and prior to the next day's trading. In alternate embodiment, reinstitution is not automatic and occurs with authorizations or input from the exchange. In preferred embodiments, reinstitution only occurs is the underlying market has moved more than a predetermined trigger distance within the brackets. The trigger distance is pre-determined by the exchange. For example, in one embodiment, the trigger distance is five points such that the underlying market must move between the brackets by at least five points. The pre-determined trigger distance is preferably the same for all bracket contracts based on the same underlying market.

In further preferred embodiments, the bracket contract is opened with a set time limit (maturity). The time limit is typically defined by administrators at the exchange as part of a bracket contract specification. In preferred embodiments, the time limit is seven days or less. In more preferred embodiments the time limit is one day or less, as active market trading is likely busiest on the day of expiry. For bracket contracts that last multiple days, the exchange preferably lists a series of bracket contracts on the same underlying market, all with the same term, for example, one week, but with different starting and expiry dates such that one bracket would expire one day, a second bracket would expire the day after, a third bracket would expire the day after that, and so forth. The bracket contract is stopped at an expiry of the time limit if present value 20 has not yet equaled the cap stop value or the floor stop value. If the bracket contract is stopped due to expiry of the time limit, the bracket contract ends and is closed exactly at the level of present value 20, and profit or loss is determined by the difference between the opening value and the present value, multiplied by the price-per-point. Stoppage of a bracket contract due to time expiry is automatic and does not require input of the exchange or exchange members. Once a bracket contract is stopped due to time expiry, there is preferably no reinstitution.

While the invention includes a time limitation, the invention provides means for automatically stopping a bracket contract prior to the expiry of a time limit with the bracket trigger stop. This contrasts existing range trades that expire automatically only at expiry a time limit. Thus, in the prior art, even if the present value touches or even exceeds a bracket value, the contract remains open. This means that the present value can slip back into the range, causing greater uncertainty for the exchange member.

Contracts cannot be stopped by election of the exchange member per se, but their effect can be cancelled out or diminished by taking an equal and opposite position that has the effect of eliminating or diminishing the user's exposure which will have the same or similar economic effect as closing a bracket contract. In rare occurrences the bracket contract may be stopped at election of the exchange, for example, after a failure in technology of the exchange providing the updated values of an underlying market. In this circumstance the exchange has the right but not the obligation to suspend related bracket contracts.

The exchange is to be regulated by a financial regulator, that is, the CFTC, the SEC and/or other regulatory body. In preferred embodiments, the exchange is regulated by the CFTC. The CFTC's view is that a futures exchange cannot reliably variation-margin a membership that consists of thousands of individuals of uncertain financial standing. As a consequence, to obtain CFTC acceptance all transactions on an electronic retail exchange must be subject to capped profits and losses so that they can be fully collateralized in advance, and the exchange is thus restricted to listing contracts where the maximum exposure of both parties is limited and exactly quantifiable in advance of the transaction, i.e., reciprocal limited risk contracts. As a consequence, in certain embodiments, particularly embodiments wherein the exchange novates a bracket contract between two exchange members, reciprocal limited risk bracket trades of the present invention are within CEA jurisdiction and comply with CFTC requirements. The bracket and bracket contracts of the invention, however, are fully functional, usable and novel regardless of the regulatory or regulatory body if any.

Further, in preferred embodiments, the invention is subject to regulation (an exchange product) as opposed to unregulated off-exchange market. Contracts are thus available to US retail customers without being limited by US federal legislation that restricts off-exchange markets to wholesale participants only. Moreover, the invention provides a means by which exchange members can enjoy the benefits of trading a geared product in a regulated environment without facing the downside of taking on unlimited risk. In alternate or additional embodiments, the brackets are offered off-exchange.

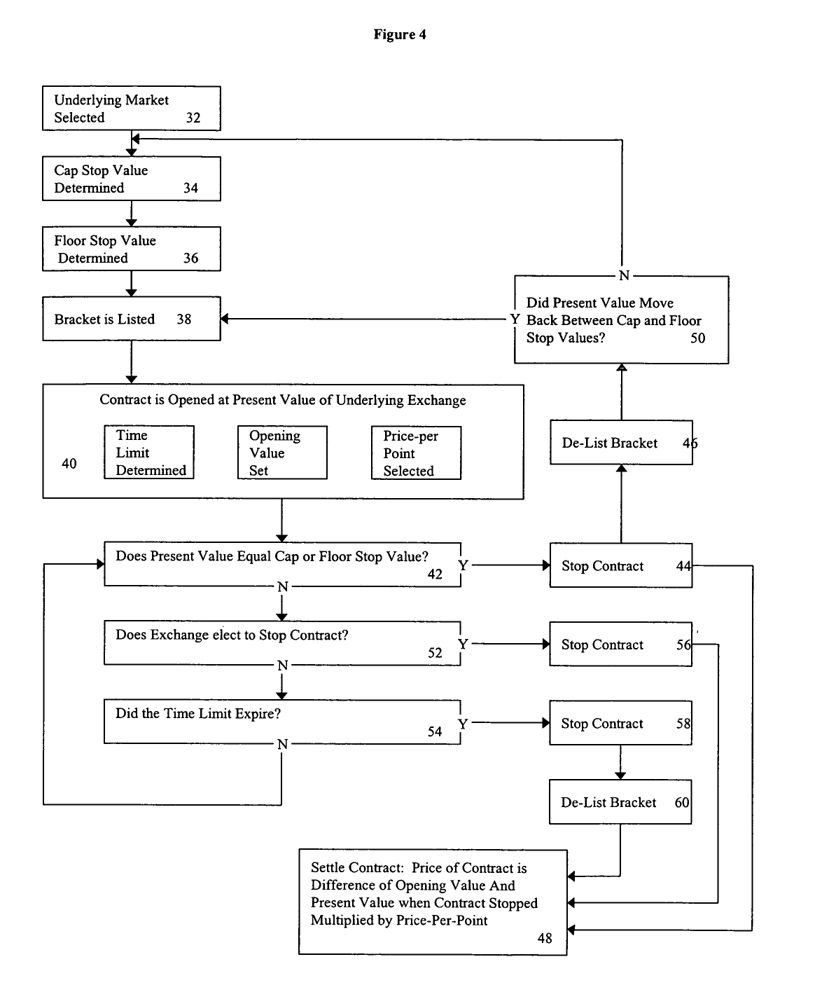

FIG. 4 is an overall method flowchart showing one embodiment of how a bracket contract based on a specific bracket is opened and settled. In step 32, an underlying market is selected. In steps 34 and 36, a bracket is determined by an exchange where the bracket is to be listed, wherein the bracket comprises two bracket stop values: a cap stop value and a floor stop value, on either side of a present index point of an underlying market. It should be understood that the determined bracket is most likely one of a variety of brackets that have likewise been determined by the exchange. In step 38, the bracket is listed as a class of bracket contract on the exchange, thereby making it active for trading. Listing is preferably done on-line on the exchange's web-based site. In step 40, an exchange member chooses to open a bracket contract based on an underlying market value that is between the bracket stop values. The underlying market value at opening is the opening value. At the time the bracket contract is opened, the exchange member further elects a time limitation, a price-per-point and/or a currency if one or all of these elections have not already been defined by the exchange. The exchange member also elects whether to go long or short on the bracket contract. If the exchange member goes long, the cap stop value is the profit-take limitation and the floor stop value is the risk limitation stop. If the exchange member goes short, the floor stop value is the profit-take limitation and the cap floor value is the risk limitation stop. Generally, the exchange member will open the contract counter-party to a second exchange member but the contract will be subsequently novated so that the exchange member will be counter-party to the exchange or its associated clearing organization.

In step 42, it is determined if the present value of the underlying market has equaled either of the risk limitation stops. If no, the bracket contract continues. If yes, the bracket contract is stopped in step 44. If the bracket contract is stopped, the bracket is suspended in step 46, and the price of bracket contract is settled based on the difference between the opening value and the bracket stop values multiplied by the price-per-point in step 48. The price can be automatically credited or debited from an exchange member's account. After settlement, it is determined in step 50 whether the underlying market value has moved back between the two bracket stop values. If so, and the time limitation has not yet expired, the bracket can be reinstituted on the exchange. Reinstituting a bracket typically occurs on the next business day. At this point, any exchange member, including the exchange member who just settled the bracket contract, can open another bracket contract on the reinstituted bracket. If not, a new bracket can be determined if desired.

If the underlying market has not equaled either of the bracket stop values, the bracket contract can still stop if the exchange elects to stop it (step 52) or if the time limitation expires (step 54). In both cases the price of the contact is settled based on the difference between the opening value and the value of the underlying market when the bracket contract was stopped multiplied by the price-per-point in step 48. If the bracket contract is stopped in step 58, then the bracket is typically suspended at 60 and not reinstituted. If the bracket contract is stopped due to election of the exchange member in step 56, the bracket is not suspended. If the bracket contract is not stopped in steps 52 and 54, the bracket contract continues until one of the three types of stoppages occur.

While FIGS. 1-4 are directed to a single bracket contract on a single bracket, is should be readily understood that the exchange can, at any given time, have a multiplicity of bracket contracts opened by one or a multiplicity of exchange members based on a variety of brackets, wherein any number of brackets may be overlapping.

In further embodiments, an exchange is provided for trading a financial instrument, wherein the exchange is visible on a web-based interface that accepts inputs from at least one exchange member and at least one administrator of the exchange. The exchange provides means to select the underlying market and the cap and floor value on either side the present value of the underlying market. This selection can be done automatically by the exchange or manually by the administrator. The invention further provides means to open a bracket contract with input from the at least one exchange member in accordance with the invention and means to stop the bracket contract at a moment where the present value equals one of the two bracket values. The means to achieve these features are preferably achieved with associated hardware, software, programming, source code, and/or object code and/or like items.

### EXAMPLE 1

It is 9:45 a.m. New York time and a New York exchange index (hereinafter called “A”) has opened little changed at 10812 points. The exchange is listing A 10750/10850 Bracket, and the quote is 10810-10814.

The exchange member decides to sell $10/point (price per point) of the A 10750/10850 Bracket at 10810. The trade will be automatically closed without spread if the middle of the exchange quoted points reaches either 10750 or 10850.

The exchange member's maximum possible loss on the trade is 10850−10810=40×$10/point=$400.

The exchange member's maximum possible profit on the trade is 10810−10750=60×$10/point=$600.

Two hours later the A index has fallen around forty points and the exchange's current quotation for A index, and thus for the A 10750/10850 Bracket, is 10768-10772. The exchange member can close his position at 10772. His profit is calculated as follows:

| | |
|---|---|
| Opening level: | 10810 |
| Closing level: | 10772 |
| Difference: | 38 |
| Profit: | 38 × $10 = $380 |

### EXAMPLE 2

It is 10:45 a.m. New York time and a London index (hereinafter called “B”) is trading at 6035 points. The exchange is listing a B 6000/6100 Bracket, and the quote is 6032-6038

An exchange member decides to buy $10/point of the B index 6000/Bracket at 6038. The trade will be automatically closed without spread if the middle of the exchange quoted points reaches either 6000 or 6100.

The exchange member's maximum possible loss on the trade is 6035−6000=35×$10/point=$350.

The exchange member's maximum possible profit on the trade is 6100−6035=65×$10/point=$650.

At 11:30 a.m. New York time the B index closes down fifty points at 5985. The exchange's FTSE 6000/6100 Bracket contract is thus settled at 6000. The exchange member's position is automatically closed at 6000 and his loss is calculated as follows:

| | |
|---|---|
| Opening level: | 6035 |
| Closing level: | 6000 |
| Difference: | 35 |
| Loss: | 35 × $10 = $350 |

Thus, it will be appreciated that unlike other futures contracts with reciprocal limited risk, the present invention provides reciprocal limited risk contracts that are priced off the underlying market in a way that exchange members and potential customers can readily understand and moves in a scalar fashion. For example, a bracket trade quote for the B index of a 6000/6100 bracket at 6035-6038 is much easier to understand than a binary option price bid asked spread of 35-38, particularly when that option price might move to 1-3 as expiry approaches. Further, the ability to trade these instruments on an exchange allows exchange members to hedge risks to which they are currently exposed and which they are unable to hedge on traditional futures exchanges economically because of the large contract sizes set by the exchanges and the expensive commissions charged by the brokers.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

We claim:

1. A system of trading futures, comprising the steps of:
selecting an underlying market having a present value, wherein the present value is a quoted point of the underlying market,
determining a cap stop value, the cap stop value a number higher than the present value,
determining a floor stop value, the floor stop value a number lower than the present value such that the cap stop value and the floor stop value form a bracket around the present value,
listing the bracket,
opening a contract based on the bracket, the contract opened at an opening value wherein the opening value is the present value at the time of opening, and
stopping the contract if a stop is triggered,
wherein the stop is triggered if the present value equals the cap stop value or the floor stop value.

2. The system of claim 1, further comprising the step of:
determining a price of the contract after stopping the contract, wherein the price of the contract is the difference between the opening value and the present value at the step of stopping the contract, multiplied by a price per point.

3. The system of claim 1, further comprising the steps of:
setting a time limit when opening the contract,
wherein the stop is triggered at an expiry of the time limit if the present value of the underlying market has not yet equaled the cap stop value or the floor stop value.

4. The system of claim 1, wherein the bracket is one of a multiplicity of brackets and wherein at least two of the multiplicity of brackets are listed.

5. The system of claim 4, wherein at least two of the multiplicity of brackets have different cap stop values, at least two of the multiplicity of brackets have different floor stop values, and at least two of the multiplicity of brackets bracket different underlying markets.

6. The system of claim 5, further comprising the step of:
suspending the bracket after stopping the contract.

7. The system of claim 6, further comprising the step of:
reinstituting the bracket after stopping the contract if the present value of the underlying market moves back between the cap stop value and the floor stop value.

8. The system of claim 1, wherein a delta of the contract is always 1 on the expiry day.

9. The system of claim 3,
wherein the time limit is seven days or less.

10. The system of claim 1, wherein the opening of a contract step occurs between two exchange members.

11. The system of claim 1, wherein the opening a contract step include the step of matching offers of exchange members to form a contract.

12. The system of claim 1, wherein the opening of a contract step occurs between an exchange member and an exchange or its associated clearing member

13. A web-based, computer implemented method of bracket trading on an exchange, comprising the steps of:
opening a contract, the contract opened at a present value of an underlying market between two bracket stop values, wherein the two bracket stop values form a bracket and correspond to potential values of the underlying market, and wherein the present value fluctuates in correlation to fluctuations in the underlying market, and
stopping the contract when the present value equals either of the two bracket stop values,
wherein that a delta of the contract is always 1 on the expiry day.

14. The method of claim 13, further comprising the step of:
settling the contract after stopping the contract, wherein the price of the contract is the difference between the present value at the opening a contract step and the present value at the stopping the contract step multiplied by a price per point.

15. The method of claim 13, further comprising the steps of:
setting a time limit when opening the contract,
stopping the contract at an expiry of the time limit if the present value of the underlying market has not yet equaled either of the two bracket stop values,
settling the contract, wherein the price of the contract is the difference between the present value at the opening a contract step and the present value at the stopping the contract at the expiry of the time limit step multiplied by a price per point.

16. The method of claim 15:
wherein the time limit is seven days or less.

17. The method of claim 13, further comprising the step of:
listing the bracket on the exchange prior to the opening of the contract step.

18. The method of claim 17, further comprising the step of:
suspending the bracket from the exchange after the present value equals either of the two bracket stop values.

19. The method of claim 18, further comprising the step of:
reinstituting the bracket on the exchange after the present value equals either of the two bracket stop values if the present value of the underlying market moves back between the two bracket stop values.

20. The method of claim 13, wherein a price of the contract correlates at an unchanging ratio with the present value throughout a lifespan of the contract.

21. The exchange of claim 13, wherein the contract is opened between two exchange members and novated thereafter so that each of the two exchange members is counter-party to the exchange.

22. The exchange of claim 13, wherein the contract is opened between an exchange members and the exchange or its associated clearing organization.

24. An exchange for trading a financial instrument comprising:
a web-based interface for accepting inputs from at least one exchange member,
means for listing a bracket on the interface, the bracket including two bracket stop values such that a present value of a selected underlying market is between the two bracket stop values, wherein the two bracket stop values correspond to potential values of the underlying market, and wherein the present value fluctuates in correlation to fluctuations in the underlying market,
means to open a contract with input from the at least one exchange member, the contract having risk and profit take limitations that correspond to the two bracket stop values, and
means to stop the contract at a moment where the present value equals one of the two bracket values.

25. The exchange of claim 24, further including means to list the bracket on the web-based interface.

26. The exchange of claim 24, further including a matching means to pair together matching offers.

27. The exchange of claim 24, wherein the contract is opened between two exchange members and novated thereafter so that each of the two exchange members is counter-party to the exchange.

28. A futures contract, comprising:
a first bracket stop value corresponding to a first potential value of an underlying market, the underlying market having a present value wherein the present value fluctuates in correlation to fluctuations in the underlying market,
a second bracket stop value corresponding to a second potential value of the underlying market,
an opening value, wherein the opening value is the present value of the underlying market at the time of an opening of the futures contract, the present value between the first and second potential values, and
a stop trigger, wherein the stop trigger stops the contract when the present value equals either of the two bracket stop values,
wherein a delta of the futures contract is always 1 on the expiry day.

29. The contract of claim 28, further comprising a price per point, wherein a settled price of the contract when the stop trigger stops the contract is the difference between the opening value and the present value at the moment when the stop trigger stops the contract multiplied by the price per point.

30. The contact of claim 28, further comprising a time limit, wherein the stop trigger further stops the contract at the expiry of the time limit.

31. The contract of claim 28, wherein the futures contract is entered into between two exchange members counter-party to each other.

32. The contract of claim 28, wherein the futures contract is entered into between an exchange member and an exchange counter-party to each other.

33. The system of claim 32, wherein the exchange member, the exchange, or both, is a market maker.

34. The contract of claim 32, wherein the stop trigger further comprises an election by the exchange to stop the contract.

35. The contract of claim 28, wherein the price per point is defined in terms of units, wherein the units are selected from the group consisting of: currency per point, weight per point, volume per point or size per point.
